(19) United States
(12) Patent Application Publication
(10) Pub. No.: US 2014/0212609 A1
(43) Pub. Date: Jul. 31, 2014

(54) REINFORCED ENCAPSULATION FOR ABRASION PROTECTION OF CABLES

(71) Applicant: AFL TELECOMMUNICATIONS, LLC., Duncan, SC (US)

(72) Inventors: Craig Stratton, Spartanburg, SC (US); Brian Herbst, Easley, SC (US); Joe Cignarale, Greer, SC (US); Brett Villiger, Simpsonville, SC (US); Michael Turenne, Simpsonville, SC (US)

(21) Appl. No.: 14/238,378

(22) PCT Filed: May 8, 2013
(86) PCT No.: PCT/US2013/040063

§ 371 Date: Feb. 11, 2014

Related U.S. Application Data
(60) Provisional application No. 61/644,074, filed on May 8, 2012.

(51) Int. Cl. F16L 11/02; G02B 6/44; H01B 7/17

(52) U.S. Cl. CPC F16L 11/02; H01B 7/17; G02B 6/443
USPC 428/35.9; 138/124; 385/100; 428/412

(57) ABSTRACT

A cable including a core, a strength member surrounding the inner metal tube, and an outer layer surrounding the first layer, wherein the outer layer includes a polycarbonate material.

### CROSS-REFERENCE TO RELATED APPLICATIONS

This application is based upon and claims the benefit of priority from U.S. Provisional Application No. 61/644,074, filed May 8, 2012, in the United States Patent and Trademark Office, the disclosures of which are incorporated herein in its entirety by reference.

### BACKGROUND

1. Field

The invention is related to a highly abrasion-resistant cable, and more particularly to a highly abrasion-resistant cable that can be deployed in oil and gas well applications.

2. Related Art and Background

Hydraulic fracturing produces fractures in the rock formation that stimulate the flow of natural gas or oil, increasing the volumes that can be recovered. Wells may be drilled vertically hundreds to thousands of feet below the land surface and may include horizontal or directional sections extending thousands of feet. Fractures are created by pumping large quantities of fluids at high pressure down a wellbore and into the target rock formation. Hydraulic fracturing fluid commonly consists of water, proppants and chemical additives that open and enlarge fractures within the rock formation. These fractures can extend several hundred feet away from the wellbore. The proppants—sand, ceramic pellets or other small incompressible particles—hold open the newly created fractures.

Cables with optical fibers, electrical wires and/or chemical injections lines may be typically placed in the well before the fracturing process in order to monitor and/or collect data about the process. These cables are typically made of a plastic jacket surrounding a metal capillary tube that contains the optical fibers, or a plastic jacket surrounding electrical wires and/or chemical injections lines. These cables can be damaged during the fracturing process because the high pressure water flow contains proppants, or other additives, that cause erosion of the metallic capillary tube, electrical wires and/or chemical injections lines.

Because of the high pressure water flow, erosion can occur quickly. For example, Table 1 show the time it takes to penetrate through the cable jacket to the metal tube for several different types of jacket materials. As a point of reference, it take about 65 seconds to penetrate a ¼ inch stainless steel tube.

TABLE 1

| Jacket Material | Penetration Time |
|---|---|
| Thermoplastic Elastomer | 20 seconds |
| Polypropylene | 22 seconds |
| Nylon | 12 seconds |

It is an object of the invention to provide a cable that can be used in environments that are highly abrasive, such as in hydraulic fracturing wells.

It is also an object of the invention to provide a cable that can survive during a hydraulic fracturing process; typically two hours or less.

### SUMMARY

Exemplary implementations of the present invention address at least the above problems and/or disadvantages and other disadvantages not described above. Also, the present invention is not required to overcome the disadvantages described above, and an exemplary implementation of the present invention may not overcome any of the problems listed above.

One embodiment of the invention is a cable, including a core, a first strength member surrounding the core, and an outer layer surrounding the strength member, wherein said outer layer comprises a polycarbonate material.

In other embodiments of the cable, the strength member is a metal tube.

In other embodiments of the cable, the outer layer includes a polycarbonate based polyurethane.

In other embodiments of the cable, it also includes a second strength member surrounding the first strength member.

In other embodiments of the cable, the second strength member includes a yarn.

In other embodiments of the cable, the second strength member includes a first layer of metal wires.

In other embodiments of the cable, the second strength member includes a second layer of metal wires.

In other embodiments of the cable, it also includes an encapsulating jacket between the first strength member and the second strength member.

In other embodiments of the cable, the core includes at least one of a metal tube with at least one optical fiber, an insulated electrical wire and an chemical injection tube.

### BRIEF DESCRIPTION OF THE DRAWING

FIG. 1 is a cross-sectional view of an embodiment of a cable according to the present invention.

FIG. 2 is a cross-sectional view of another embodiment of a cable according to the present invention.

FIG. 3 is a cross-sectional view of another embodiment of a cable according to the present invention.

FIG. 4 is a cross-sectional view of another embodiment of a cable according to the present invention.

### DETAILED DESCRIPTION

The following detailed description is provided to gain a comprehensive understanding of the methods, apparatuses and/or systems described herein. Various changes, modifications, and equivalents of the systems, apparatuses and/or methods described herein will suggest themselves to those of ordinary skill in the art. Descriptions of well-known functions and structures are omitted to enhance clarity and conciseness.

Hereinafter, an exemplary embodiment will be described with reference to accompanying drawings.

The invention is directed to a reinforced plastic encapsulation around a metallic downhole cable for optical fiber, electrical conductors, or chemical injection lines installed downhole and subject to damage during hydraulic fracturing. The invention involves embedding synthetic or metallic strength members within the cross section of the encapsulating material to serve as a protecting barrier against damage caused by high pressure water flow containing sand, proppants, or other additives that cause erosion of the metallic capillary tube housing the fiber optic cable or the electrical cable or the chemical injection line. The strength member may be aramid yarns, metallic wires or any other material added as a layer in the encapsulation or distributed within the encapsulation. The strength members may be applied helically, contra-helically, braided or bunched, or longitudinally applied. Furthermore, the cable may include encapsulations like polyurethanes for their ability to resist abrasion as well as synthetic and natural rubber compounds for both high temperature and abrasion resistance capabilities.

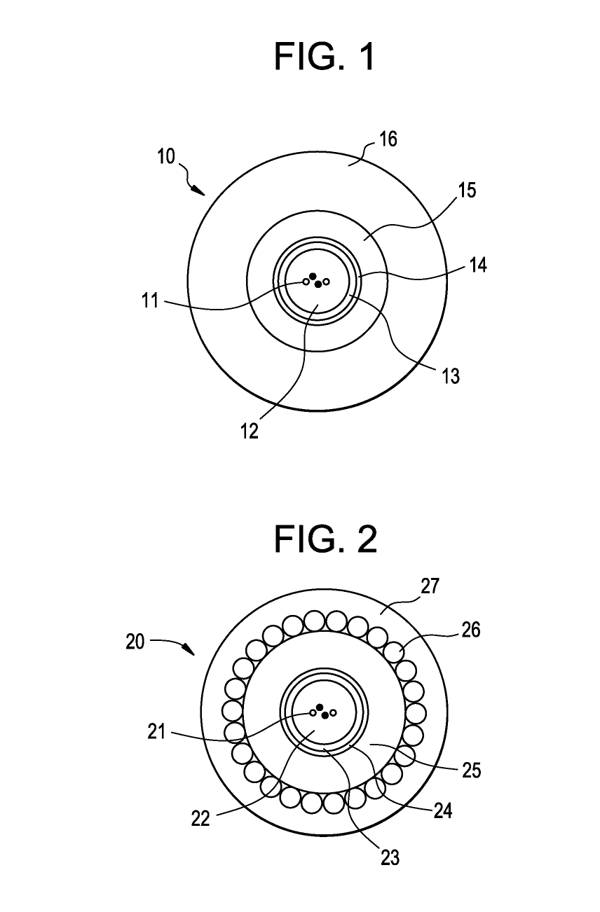

Referring to the drawings, FIG. 1 is a cross-sectional view of a cable 10 according to an exemplary embodiment of the invention. In this embodiment, cable 10 has a core with an inner metal tube 13, such as a ⅛ inch stainless steel tube with a 0.008″ thickness; however, other metals, diameters and thicknesses may be used. The tube may contain elements 11, such as optical fibers. A gel 12, may also be in the inner metal tube 13. A strength member 15 surrounds the inner metal tube 13. The strength member 15 may have a tight fit around the inner metal tube 13, or there may be a space 14 between the strength member 15 and inner metal tube 13. In this embodiment, the strength member 15 is a ¼ inch stainless steel tube with a 0.049″ thickness; however, other metals, diameters and thicknesses may be used. Surrounding the strength member 15 is an outer layer 16 made of an abrasion resistant encapsulant, with a 0.097″ thickness. In this embodiment, the outer layer 16 contains a polycarbonate material that has high temperature and abrasion resistant properties. In a preferred embodiment, the outer layer 16 is an injection moldable polycarbonate based aromatic thermoplastic polyurethane material. In other preferred embodiments, the outer layer should be capable of operating at temperatures up to approximately 150 degrees C. In other embodiments, the core, including the inner metal tube 13, gel 12 and optical fibers 11, could be replaced with core of an insulated electrical conductor or a chemical injection tube.

One configuration of this embodiment has the following characteristics:

| | |
|---|---|
| Outside Diameter | 0.445 inches |
| Wall Thickness | 0.097 inches |
| Jacket Type | polycarbonate based aromatic thermoplastic |
| | polyurethane |
| Fiber Count | 4 |
| Fiber Type | 2 × 50 um MM + 2x Ge doped SM - Carbon, |
| | Mid-temp dual acrylate coated |
| Thixotropic Gel | Hydrogen Scavenger - partial fill |

| | Metric | | English | |
|---|---|---|---|---|
| Weight | 311.4 | kg/km | 208.8 | lbs/1000 ft |
| Tensile Strength | 1407.7 | kg | 3102.5 | lbs |
| Yield Strength | 1198.0 | kg | 2640.4 | lbs |
| Strain @ Yield | 0.305 | % | 0.305 | % |
| Thermal Expansion | 1.73E−05 | m/m C. | 9.00E−06 | in/in F. |
| Hydrostatic Pressure | 23 | kg/mm2 | 33394 | psi |
| Burst Pressure | 28 | kg/mm2 | 39238 | psi |
| Working Pressure | 19 | kg/mm2 | 26847 | psi |
| Dynamic Bend | 355 | mm | 14.0 | in |
| Radius | | | | |
| Static Bend Radius | 82 | mm | 3.2 | in |
| Maximum | 150 | Degrees C. | 302 | Degrees F. |
| Temperature | | | | |

In this embodiment, the time it takes to penetrate through the abrasion resistant encapsulant to the inner metal tube is approximately 50 seconds.

Referring to the drawings, FIG. 2 is a cross-sectional view of a cable 20 according to an exemplary embodiment of the invention. In this embodiment, cable 20 has a core with an inner metal tube 23, such as a ⅛ inch stainless steel tube with a 0.008″ thickness; however, other metals, diameters and thicknesses may be used. The tube may contain elements 21, such as optical fibers. A gel 22, may also be in the inner metal tube 23. A strength member 25 surrounds the inner metal tube 23. The strength member 25 may have a tight fit around the inner metal tube 23, or there may be a space 24 between the strength member 25 and inner metal tube 23. In this embodiment, the strength member 25 is a ¼ inch stainless steel tube with a 0.049″ thickness; however, other metals, diameters and thicknesses may be used. Another strength member 26 surrounds the strength member 25. In this embodiment, the strength member 26 may be made of helically, contra-helically, braided or bunched metal wires, typically galvanized improved plow steel at 1 mm diameter; however, other metals, diameters and thicknesses may be used. Surrounding the strength member 26 is an outer layer 27 made of an abrasion resistant encapsulant, with a 0.079″ thickness. In this embodiment, the outer layer 27 contains a polycarbonate material that has high temperature and abrasion resistant properties. In a preferred embodiment, the outer layer 27 is an injection moldable polycarbonate based aromatic thermoplastic polyurethane material. In other preferred embodiments, the outer layer should be capable of operating at temperatures up to approximately 150 degrees C. In other embodiments, the core, including the inner metal tube 23, gel 22 and optical fibers 21, could be replaced with a core of an insulated electrical conductor or a chemical injection tube.

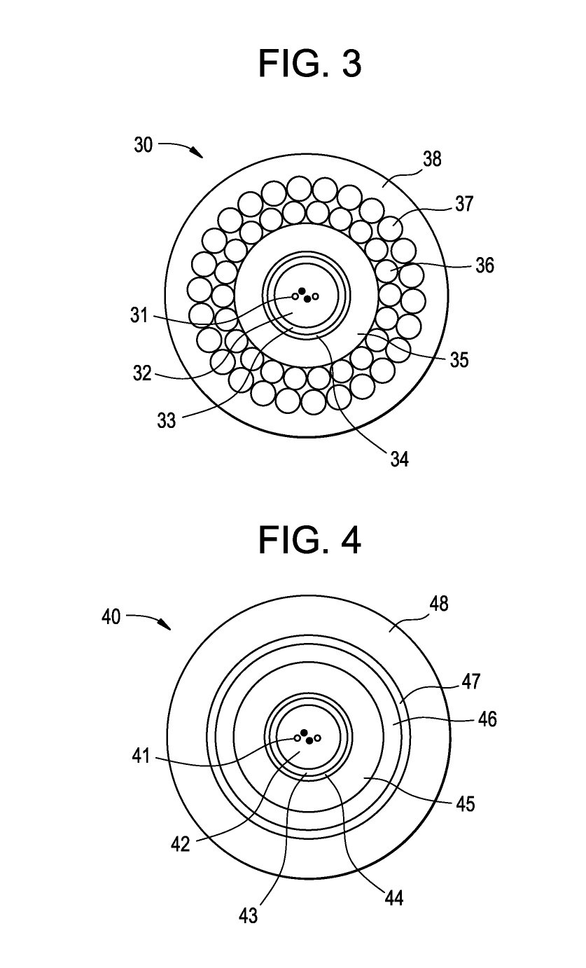

Referring to the drawings, FIG. 3 is a cross-sectional view of a cable 30 according to an exemplary embodiment of the invention. In this embodiment, cable 30 has a core with an inner metal tube 33, such as a ⅛ inch stainless steel tube with a 0.008″ thickness; however, other metals, diameters and thicknesses may be used. The tube may contain elements 31, such as optical fibers. A gel 32, may also be in the inner metal tube 33. A strength member 35 surrounds the inner metal tube 33. The strength member 35 may have a tight fit around the inner metal tube 33, or there may be a space 34 between the strength member 35 and inner metal tube 33. In this embodiment, the strength member 35 is a ¼ inch stainless steel tube with a 0.049″ thickness; however, other metals, diameters and thicknesses may be used. Two other strength members 36 and 37 surround the strength member 35. In this embodiment, the strength members 36 and 37 may be made of helically, contra-helically, braided or bunched metal wires, typically galvanized improved plow steel at 1 mm diameter; however, other metals, diameters and thicknesses may be used. Surrounding the strength member 37 is an outer layer 38 made of an abrasion resistant encapsulant, with a 0.079″ thickness. In this embodiment, the outer layer 38 contains a polycarbonate material that has high temperature and abrasion resistant properties. In a preferred embodiment, the outer layer 38 is an injection moldable polycarbonate based aromatic thermoplastic polyurethane material. In other preferred embodiments, the outer layer should be capable of operating at temperatures up to approximately 150 degrees C. In other embodiments, the core, including the inner metal tube 33, gel 32 and optical fibers 31 could be replaced with a core of an insulated electrical conductor or a chemical injection tube.

Referring to the drawings, FIG. 4 is a cross-sectional view of a cable 40 according to an exemplary embodiment of the invention. In this embodiment, cable 40 has a core with an inner metal tube 43, such as a ⅛ inch stainless steel tube with a 0.008″ thickness; however, other metals, diameters and thicknesses may be used. The tube may contain elements 41, such as optical fibers. A gel 42, may also be in the inner metal tube 43. A strength member 45 surrounds the inner metal tube 43. The strength member 45 may have a tight fit around the inner metal tube 43, or there may be a space 44 between the strength member 45 and inner metal tube 43. In this embodiment, the strength member 45 is a ¼ inch stainless steel tube with a 0.049″ thickness; however, other metals, diameters and thicknesses may be used. An encapsulating jacket 46 made of an abrasion resistant encapsulant, such as described above, surrounds the strength member 45. It may have a thickness of 0.039″; however, other thicknesses may be used. Another strength member 47 surrounds the encapsulating jacket 46. In this embodiment, the strength member 47 may be made of aramid yard; however, other yarns may be used. The denier of the yarn is dependent on the tensile requirement of the cable. Surrounding the strength member 47 is an outer layer 48 made of an abrasion resistant encapsulant, with a 0.079″ thickness. In this embodiment, the outer layer 48 contains a polycarbonate material that has high temperature and abrasion resistant properties. In a preferred embodiment, the outer layer 48 is an injection moldable polycarbonate based aromatic thermoplastic polyurethane material. In other preferred embodiments, the outer layer should be capable of operating at temperatures up to approximately 150 degrees C. In other embodiments, the core, including the inner metal tube 43, gel 42 and optical fibers 41 could be replaced with a core of an insulated electrical conductor or a chemical injection tube.

As mentioned above, although the exemplary embodiments described above are various fiber optic cables, they are merely exemplary and the general inventive concept should not be limited thereto, and it could also apply to other types of cables.

What is claimed:

1. A cable, comprising:
a core;
a first strength member surrounding said core; and
an outer layer surrounding said strength member;
wherein said outer layer comprises a polycarbonate material.

2. The cable of claim 1, wherein said strength member is a metal tube.

3. The cable of claim 2, wherein said outer layer comprises a polycarbonate based polyurethane.

4. The cable of claim 1, further comprising a second strength member surrounding said first strength member.

5. The cable of claim 4, wherein said outer layer comprises a polycarbonate based polyurethane.

6. The cable of claim 4, wherein said second strength member comprises a yarn.

7. The cable of claim 6, wherein said outer layer comprises a polycarbonate based polyurethane.

8. The cable of claim 4, wherein said second strength member comprises a first layer of metal wires.

9. The cable of claim 8, wherein said outer layer comprises a polycarbonate based polyurethane.

10. The cable of claim 6, wherein said second strength member comprises a second layer of metal wires.

11. The cable of claim 10, wherein said outer layer comprises a polycarbonate based polyurethane.

12. The cable of claim 4, further comprising an encapsulating jacket between said first strength member and said second strength member.

13. The cable of claim 5, further comprising an encapsulating jacket between said strength member and said second strength member.

12. The cable of claim 6, further comprising an encapsulating jacket between said strength member and said second strength member.

13. The cable of claim 7, further comprising an encapsulating jacket between said strength member and said second strength member.

14. The cable of claim 2, wherein said core comprises at least one of a metal tube with at least one optical fiber, an insulated electrical wire and an chemical injection tube.

15. The cable of claim 3, wherein said core comprises at least one of a metal tube with at least one optical fiber, an insulated electrical wire and an chemical injection tube.

16. The cable of claim 4, wherein said core comprises at least one of a metal tube with at least one optical fiber, an insulated electrical wire and an chemical injection tube.

17. The cable of claim 5, wherein said core comprises at least one of a metal tube with at least one optical fiber, an insulated electrical wire and an chemical injection tube.

18. The cable of claim 6, wherein said core comprises at least one of a metal tube with at least one optical fiber, an insulated electrical wire and an chemical injection tube.

19. The cable of claim 7, wherein said core comprises at least one of a metal tube with at least one optical fiber, an insulated electrical wire and an chemical injection tube.

20. The cable of claim 8, wherein said core comprises at least one of a metal tube with at least one optical fiber, an insulated electrical wire and an chemical injection tube.

21. The cable of claim 9, wherein said core comprises at least one of a metal tube with at least one optical fiber, an insulated electrical wire and an chemical injection tube.

22. The cable of claim 10, wherein said core comprises at least one of a metal tube with at least one optical fiber, an insulated electrical wire and an chemical injection tube.

23. The cable of claim 11, wherein said core comprises at least one of a metal tube with at least one optical fiber, an insulated electrical wire and an chemical injection tube.

24. The cable of claim 12, wherein said core comprises at least one of a metal tube with at least one optical fiber, an insulated electrical wire and an chemical injection tube.

25. The cable of claim 13, wherein said core comprises at least one of a metal tube with at least one optical fiber, an insulated electrical wire and an chemical injection tube.
